(19) United States
(12) Patent Application Publication
(10) Pub. No.: US 2003/0040277 A1
(43) Pub. Date: Feb. 27, 2003

(54) Apparatus and method for measuring and identifying sources of communications interference

(76) Inventor: Bradley W. Deats, Parker, CO (US)

Correspondence Address: Bruce A. Kugler, Esq., SHERIDAN ROSS P.C., Suite 1200, 1560 Broadway, Denver, CO, 80202-5141, US

(21) Appl. No.: 09/888,101

(22) Filed: Jun. 22, 2001

Related U.S. Application Data
(60) Provisional application No. 60/219,254, filed on Jul. 18, 2000.

(51) Int. Cl. H04B 1/10

(52) U.S. Cl. 455/63; 455/423

(57) ABSTRACT

The present invention relates to an apparatus and method used to measure and identify sources of communications interference. In one embodiment a test instrument includes multiple receivers designed for reception of radiated radio signals in free space. The resulting measured signals are processed to determine if there is a mathematical and/or timing relationship between the parent transmitter(s) suspected of causing the interference, and the actual measured interference in the spectrum being evaluated, and providing a ranked list of possible interferers.

### CROSS REFERENCE TO RELATED APPLICATIONS

Priority is claimed from U.S. Provisional Patent Application Serial No. 60/219,254 filed Jul. 18, 2000 entitled “Apparatus and Method for measuring and Identifying Sources of Communications Interference,” and further identified as attorney docket number 4229-3PROV, the disclosure of which is incorporated herein by reference in its entirety.

### FIELD OF THE INVENTION

The present invention relates generally to communication systems of all mediums (radio frequency, optical, sonic, etc.) and is particularly designed for use in radio frequency communication applications to determine sources of communication interference.

### BACKGROUND OF THE INVENTION

Communications receivers are generally designed to detect and demodulate signal levels which are very low in power. Occasionally, these desired signals are present along with undesired signals. In the United States, the Federal Communications Commission (hereinafter “FCC”) carefully regulates the location, frequency, power level, and gain of radio frequency (hereinafter “RF”) transmitters to minimize the presence of these undesired signals (otherwise known as interference) in RF communication systems. However, despite these measures, malfunctioning transmitters, interactions of adjacent transmitters, and even the presence of decaying mechanical junctions (e.g. rain gutters) can cause interference, thus affecting the quality of reception of numerous devices which utilize RF signals such as cell phones and other communications apparatus. Based on the tremendous sums of money spent annually by industry to identify sources of communications interference, a great need exists for a cost efficient, effective method for identifying sources of communications interference.

FIG. 1 illustrates a simple communication system. Each party desires to transmit one or more channels of information across a common medium. The signals are typically modulated in some fashion, and then launched into the common medium (examples of such medium include free space and coaxial cable). This modulation and launching process typically produces not only the desired signals, but also signals at a much lower level which are not desired and are not typically in the intended frequency/wavelength range. Further, while traveling through the medium, these signals can combine in a non-linear fashion to produce additional unwanted signals.

The presence of these unwanted, or interfering signals in a communication system can adversely impact the capacity of the communication system and/or the quality of the information passed across this communication system. For example, in a wireless RF data link, the effective bandwidth of the data link may be reduced by the presence of interference. In a second example, the quality of the spoken voice may become unintelligible using a wireless RF telephone which excessive interference levels. When such symptoms of interference appear, it is desired to locate and mitigate the cause of the interference as quickly as possible. Using current practice, this typically involves taking signal receiver to the communications medium along with a directional probe to determine the source of the interfering energy. For example, RF communications interference is typically located by using an RF spectrum analyzer together with a directional antenna to determine the direction from which interfering signals are arriving.

Difficulties presented by currently known techniques include:

1) The interfering energy can be caused by an interaction of multiple transmitters. Although the primary source of the energy can be determined, the identity of the other contributing transmitter(s) is/are unknown;

2) The interfering energy is typically present with desired signals within the spectrum containing interference and differentiating between the two types of signals can be difficult;

3) The offending transmitters may not be generating interference on a continual basis. This requires tedious, continuous human monitoring of the spectrum until the interference occurs. This can be costly in terms of manpower and resources;

4) The source of the interfering signals is often traced to a group of transmitters. Isolating the specific transmitter or transmitters responsible for the interference often requires individually shutting down suspect transmitters until the interference is mitigated. This is undesirable as it interrupts communications on a nominally functional communications system; and

5) The source of the RF interference may be a metallic object which is re-radiating signals from nearby transmitters. Although the source of the interference is readily determined (i.e., the metallic object), the identity of the specific transmitters which are stimulating a response from this object is not readily determined.

For these reasons, mitigating interference problems in communication systems can be a time consuming task. Because this operation typically involves highly trained personnel, this exercise can be extremely expensive. Further, while the interference problem is being solved, communications quantity and/or quality is being affected, thus adversely impacting revenues for the entity providing the communications service. A significant need thus exists for a device and method which can rapidly and clearly identify the source (or sources) of interference in a communication system which can dramatically decrease the costs relating to interference.

### SUMMARY OF THE INVENTION

The present invention relates to an apparatus and methods for identifying unwanted interference in communication applications. In one application of the present invention, a portable instrument is provided with the capability to detect and identify the source of interference in an RF communications system. The instrument in one embodiment comprises one or more independent receivers (a plurality of receivers) controlled from a central controller. Each receiver utilizes a common sample clock which allows for time- synchronous (coherent) signal detection.

Prior to interference detection, an understanding of the RF environment in the proximity of the interference problem is established. This is generally achieved by utilizing one or more methods, including: 1) referencing a data storage means that contains an internal database of licensed transmitters in the area (a regulatory license database); 2) referencing a data storage means that contains an internal database of unlicensed transmitters which are likely to be in the area; and/or 3) referencing a data storage means that contains an internal experience-based historical database of transmitters which the instrument of the present invention creates and updates based on measurements taken during the current and/or prior visits to the site.

This third database is derived from the instrument's ability to automatically identify the presence of new transmitters in the area. This is achieved by comparing broad spectral sweeps with a very fine resolution across a wide bandwidth. These sweeps are compared to the historical data collected and stored within the internal data storage means for the current site. New transmitters are added to the database for future reference and comparison. The operator is notified of any new transmitters detected at the site. This helps the operator isolate potential sources of new interference since the last visit to the site.

Through the use of a plurality of receivers, both the interference and the associated transmitted signals can be simultaneously monitored. Using correlation techniques, the mathematical relationship between the hypothetical interference signature and the actual interference signature can be established. This relationship determines if the parent transmitter signals are likely related to the measured actual interference signals. In this way, the likely source of interference within a communications band can be readily identified quickly and efficiently.

To further aid in efficiently finding the source (or sources) of interference, in another aspect of the present invention an integral global positioning system (hereinafter “GPS”) receiver is utilized to determine a physical location of the test site. This information is used to access an internal database of all known transmitters in proximity of the test site. By knowing what transmitters are nearby, and knowing their power output and frequency ranges, the instrument automatically tunes itself to the critical test frequencies. This minimizes the expertise the operator must possess to operate the instrument and locate the source of interfering signals.

In another aspect of the present invention, the versatility of the measuring instrument may be further extended by including the ability to automatically determine the direction of arrival of measured interfering signals. When so equipped, the instrument of the present invention includes an interface to a directional (or steerable) antenna which provides a maximum (or minimum) signal output when pointed in the direction of the transmitter being evaluated. The user then enters the angular position of this antenna into the instrument. Alternatively, the instrument reads angular positions directly from the external antenna when it is equipped with a device which provides angular position relative to magnetic North (e.g. a flux gate). The received interference and transmitter signals are then measured with respect to not only frequency and time, but also with respect to angle of arrival and peak signal strength. This composite information set allows the further and more refined identification of transmitters which are causing interference which may not be included within the other sources of reference data.

As more than one transmitter (or combination of transmitters) may produce communication interference, the present invention identifies and lists all transmitters (or combination of transmitters) which can produce interference in the band of interest. Each transmitter (or combination of transmitters) is automatically or manually evaluated using both theoretical and empirical measurements. The results are presented to the user in one embodiment in the form of a score or graduated measurement. This score forms a ranking system that allows the most likely sources of interference to be quickly identified. A higher score means there's an increasing likelihood that a particular transmitter (or combination of transmitters) is responsible for generating interference in the band of interest. Alternatively, other types of output displays such as bar graphs, metering devices and other measurement devices commonly known in the art can be used for the same purpose.

When the evaluation is completed, a visual display of one or more reports are available to the user of the instrument detailing the reasons why it is believed that each transmitter (or combination of transmitters) is, or is not, responsible for generating interference in the band of interest. This report may then be presented to the party responsible for maintaining the transmitters involved in order to solicit help in mitigating the interference.

Thus, in one aspect of the present invention, an apparatus is provided which is adapted for identifying sources of electromagnetic interference, comprising:

a plurality of receivers adapted for receiving and measuring radio signals at multiple bandwidths which are generated by one or more transmitters at one or more locations;

a data input means;

a data storage means for storing information related to the location and signals generated by each of said one or more transmitters; and

a central processing unit for creating a hypothetical interference signature from said one or more transmitters and correlating this hypothetical interference signature with an actual interference signature measured from said one or more transmitters, wherein a visual display identifying a relative likelihood that said one or more transmitters is generating the radio frequency interference may be identified.

Furthermore, in another aspect of the present invention, a method is provided for identifying sources of radio frequency interference, and comprising the steps of:

identifying a geographical location of an apparatus having at least one receiver adapted for receiving radio signals at multiple bandwidths;

receiving and measuring radio signals with said at least one receiver, said radio signals generated from one or more transmitters positioned at one or more physical locations;

storing data in a data storage means, the data related to a location and the radio signals generated from each of said one or more transmitters;

generating a hypothetical interference signature from signals received from said one or more transmitters and from the data known about each of said one or more transmitters;

correlating said hypothetical interference signature with a signal measured from one of the said receivers; and

identifying which of said one or more transmitters is creating the radio frequency interference.

### BRIEF DESCRIPTION OF THE DRAWINGS

FIG. 1 depicts a typical communication system showing two of potentially many transmitter-receiver pairs;

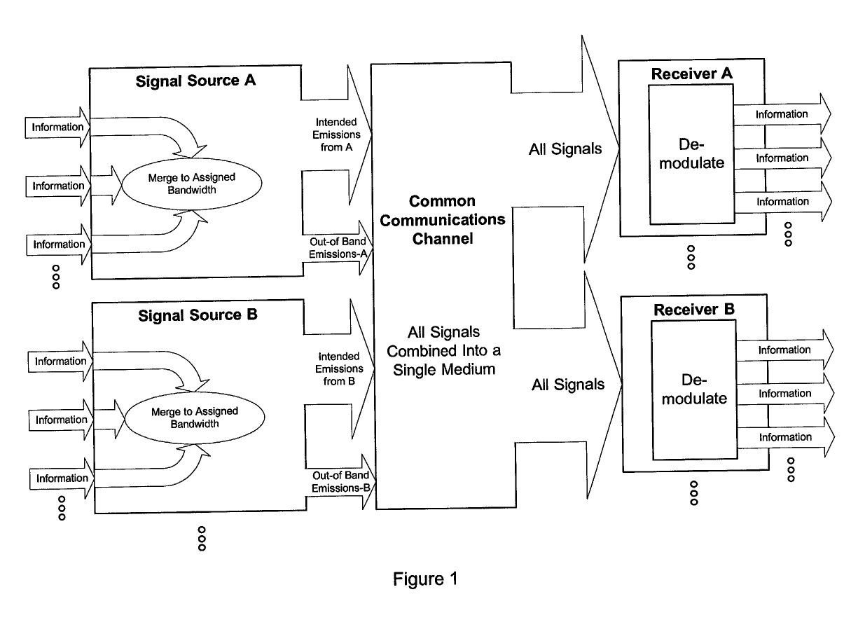

FIG. 2 is a receiver array diagram illustrating the coherent and synchronous capture and digitizing of multiple communication waveforms;

FIG. 3 is an information flow diagram illustrating the methodology to evaluate and identify interfering signals within a communications channel;

FIG. 4 identifies the intended emissions from one or more sources converted to digital waveforms and used to generate a hypothetical out-of band emissions signature.

FIG. 5 is an illustration of the method used to generate the hypothetical interference waveform from the measured parent waveforms;

FIG. 6 shows the interference analyzer outer hardware visual display screen and accessory antenna together with a simplified block diagram in one embodiment of the present invention;

FIG. 7 is a receiving hardware block diagram illustrating the application of a plurality of receivers to identify sources of interference; and

FIG. 8 identifies a process for complex signal correlation methodology and signal flow which compares a hypothetical and measured interference signature to determine the likely source of the measured interfering signal.

### DETAILED DESCRIPTION

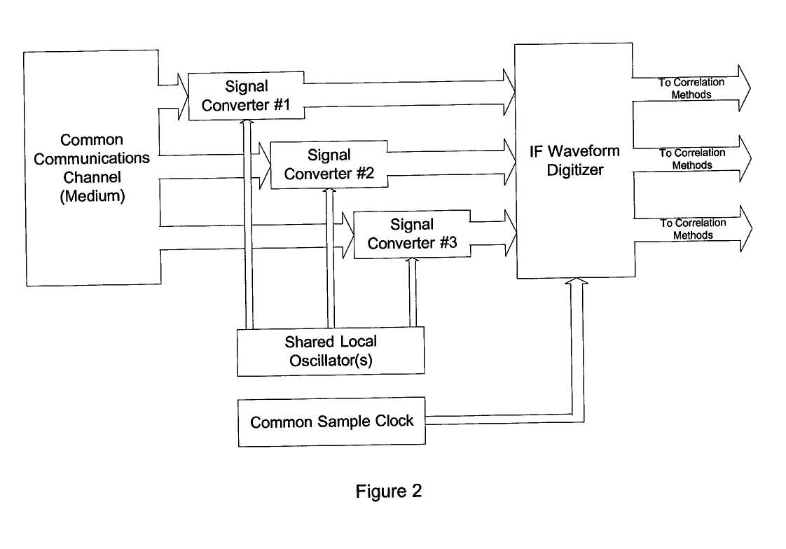

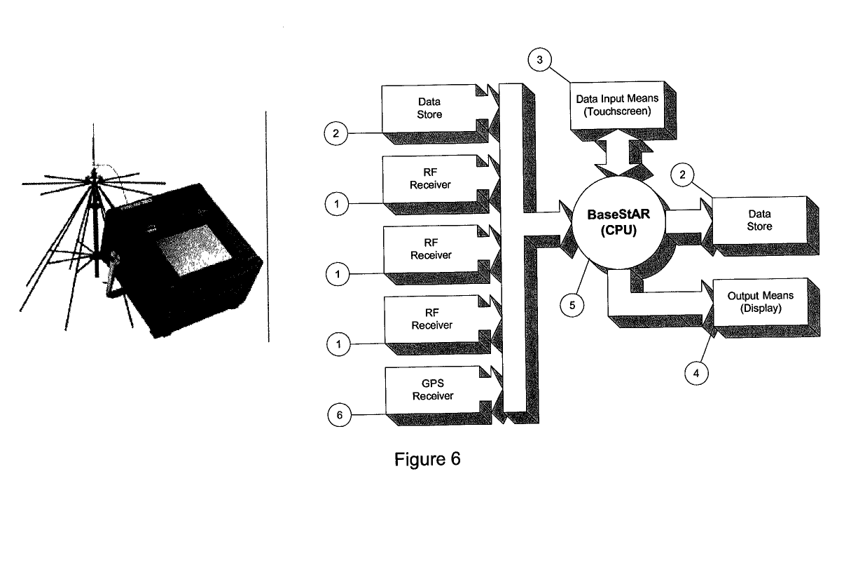

Referring now to the drawings, in one physical embodiment of the present invention, a device is provided as shown in FIG. 6. Within the instrument enclosure are three wideband (50 MHz to 2.3 GHz) receivers designed for receiving signals from an antenna as shown in FIG. 2. The instrument also includes in one embodiment an on-board GPS receiving and integrated antenna. As appreciated by one skilled in the art, a stand-alone GPS receiving and antenna could also be used and interconnected to the enclosure as well as the alternative ability to manually enter the location of the measurement using a map, or using the manual entry of latitude/longitude coordinates. The instrument is designed for field use and thus has a durable outer protective covering. Further, the instrument can be operated through the touchscreen interface in direct sunlight, or alternatively with a keyboard or other form of data input device could be used to input data or operating instructions.

Physical Characteristics

The physical characteristics of the numerous components provided in the apparatus shown in FIG. 6 are generally as provided below:

a) visual display and integrated touchscreen interface readable in direct sunlight, or alternatively a keyboard, microphone, or other transducer could be used to input data or operating instructions;

b) a non-volatile memory which provides a data storage means. This can be a flash disk, hard disk, or other data storage medium;

c) a central processing unit used to interact with the operator, control the functions of the hardware, read/write to/from the data storage medium, and perform mathematical processing of the measured and stored data;

d) a GPS receiver and integrated antenna. This function may be alternatively replaced by the manual input of location or map-based selection of current location; and

e) one, two, or three wideband receivers designed for receiving signals from an antenna as shown in FIGS. 2 and 6. These receivers are designed to tune across the frequency range of 50 MHz to 2300 MHz with a 15 MHz instantaneous bandwidth (each). However, receivers covering a wider or narrower tuning range and having a wider or narrower instantaneous bandwidth may also be used as appreciated by one skilled in the art.

RF Signal Connections

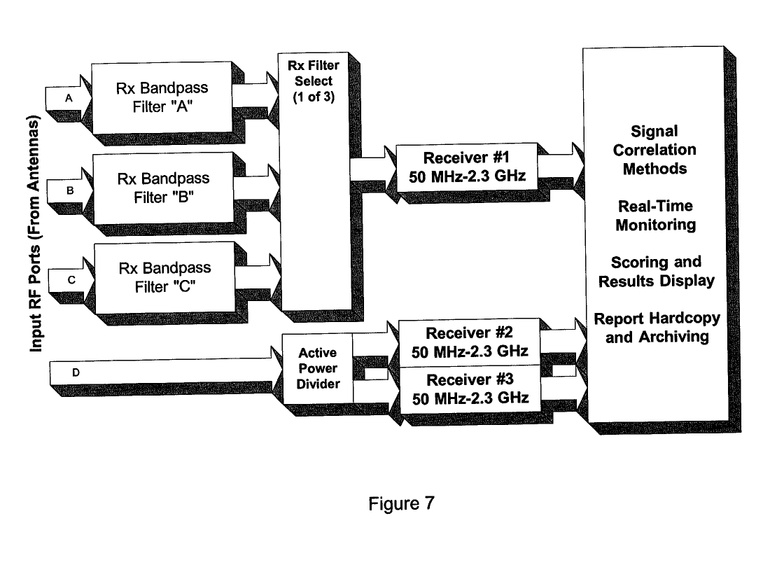

As illustrated in FIG. 7, one of the three receivers within the instrument is preferably preceded by a cavity bandpass filter. This filter's passband is tuned for operation within the frequency range of interest (where interference is to be detected). This filter prevents the generation of instrument-induced interference (e.g. intermodulation) at the input of the receiver due to high power, out-of-band signals. The remaining receiver(s) are connected directly to the wideband antenna input at the rear panel of the unit. The two receivers which are not preceded by a filter are used to measure the parent carriers. These carriers are tested to see if they are responsible for generating interference in the band of interest.

Due to the nature of the signal processing used to correlate the transmitted signals with the resulting interference waveforms, the internal receivers are capable of digitizing up to 15 MHz of alias-free bandwidth in a single data capture. This bandwidth corresponds to the maximum amount of bandwidth typically assigned to a single communications channel.

To increase the speed of the measurement process, the instrument is preferably designed to measure signals both through a direct cable connection to the existing communications equipment, or through a supplied antenna. Utilizing the antenna allows signals to be measured without physically connecting the instrument to the existing communications equipment. This allows multiple communication sites to be quickly evaluated.

The instrument finctions by following a predefined sequence of events which lead to the detection and identification of the likely interference source. These events are described as set forth below:

Determining Measurement Context (Position)

The first step in one method of the current invention is to determine the context of the interference. In other words, the physical location where the interference is occurring has a direct impact on how the search for the cause of the interference is performed.

The method is initiated with the instrument being physically located at the site which is experiencing interference, and the unit is turned on. The current location of the instrument is determined in one of four ways:

1. User-input Latitude/Longitude, which can be obtained from commonly known maps.

2. User-input map-based location (select on a map displayed on the visual display).

3. Selecting a previously defined benchmark location previously stored from a prior visit to the current location.

4. On-board GPS receiver location data.

Once the instrument's location is determined, a listing of transmitters and their salient characteristics within a user-defined radius of the current location is built. The transmitter information which is searched to build this list generally includes the following:

1. An internal licensed database of transmitters registered with the local regulatory agency. This data is contained within the internal data storage means.

2. User defined transmitters. This list, stored on the internal data storage means, consists of transmitters which have either been entered manually by the user or automatically entered based on measured spectrum measurements in prior or current visits to site location.

3. Default transmitters which are likely to exist, but are not specifically geographically licensed. Examples of such transmitters in the United States include, but are not limited to, cellular telephone service providers, amateur transmitters, and FCC Part 15 devices.

4. Transmitters Otherwise Identified. Using direction/position correlation, the instrument compares the angle of arrival of signals and confirms their emissions frequency range and geographic location with those in the database. The angle of arrival is determined by a directional antenna which either physically rotates, or is electrically pattern-steered. If no match between angle of arrival, emissions frequency, and geographic position is detected, the detected emission is evaluated for possible interference generating characteristics relative to the band of interest. If it is possible for this newly identified transmitter to produce interference within the protected band (alone or in concert with one or more identified transmitters), then this transmitter is considered a new suspect. This suspect is then evaluated with the normal correlation algorithms described below to determine if it is actually responsible for causing interference in the band of interest.

The salient characteristics stored may include, but are not limited to:

1. Probable transmitter owner.

2. Transmitter frequency range of operation.

3. Transmitter output power, gain, and/or effective radiated power.

4. Transmitter location.

5. Probable modulation formats and type of information transmitted.

6. Transmitter call sign.

7. Additional information which is available for the geographic region in which the instrument is operated.

Because many licenses and users can exist for adjacent (or nearly adjacent) frequencies at the same location, the instrument assumes a single radiating element is used for all of these frequency bands. A single (or several) larger bandwidth transmitters are synthesized from many, many smaller bandwidth, but co-located transmitters listed in the database. This task is known as band concatenation and significantly reduces the amount of time spent evaluating transmitters as to their responsibility for causing interference.

To improve the speed and flexibility of these database operations, ODBC compliant databases and queries are used to track lists of transmitters and suspects in each historical location where the instrument has been used.

Specify the Interference Band of Interest

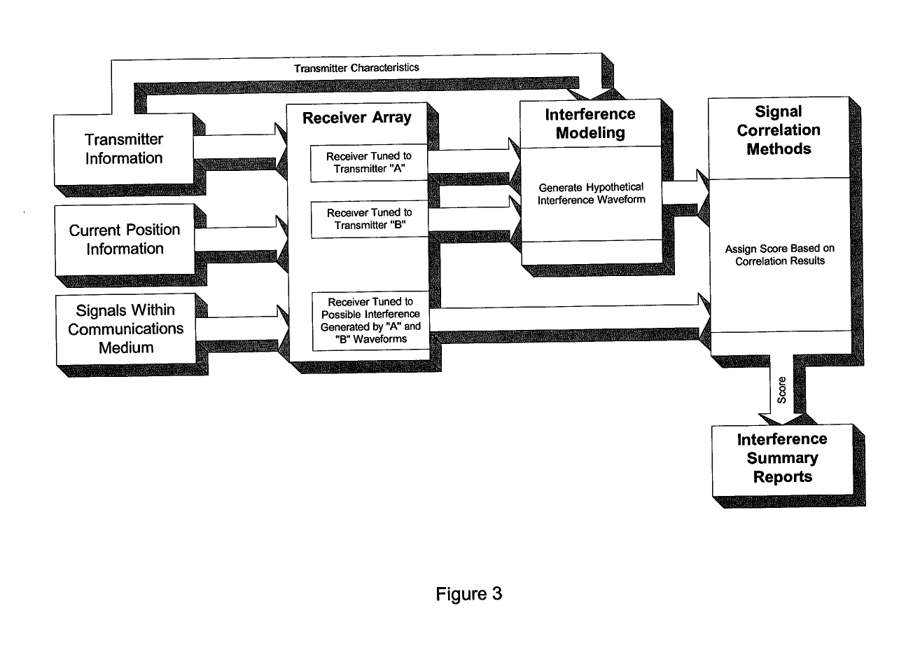

Once all of the nearby transmitters are known to the instrument, the user then specifies which band (or bands) of frequencies are to be evaluated for the presence of interference. With this information, the instrument is able to evaluate each proximal transmitter individually, and combinations of transmitters severally to determine if it is mathematically possible for interference to be generated within the band of interest. Each transmitter, or combination of transmitters that can generate interference is designated as a “suspect” and placed in a listing presented to the user. This list forms a hypothetical list of transmitters that can generate interference within the specified frequency range. The data generated from this method is illustrated generally in FIG. 3.

In one embodiment of the present invention, the instrument uses the following mathematical relationship to determine if the frequency range of suspect transmitters' intended emissions can cause interference landing within the receive band of interest:

F_{H}(n,m)=MAX{nf_{A}±mf_{B}} for all F_{Alow}≦F_{A}≦F_{Ahigh} and F_{Blow}≦F_{B}≦F_{Bhigh} F_{L}(n,m)=MIN{nf_{A}±mf_{B}} F_{Alow}≦F_{A}≦F_{Ahigh} and F_{Blow}≦F_{B}≦F_{Bhigh} and for all n≦N and m≦M

where:

F_{H} is the high frequency limit of the resulting interference waveform.

F_{L} is the low frequency limit of the resulting interference waveform.

F_{Alow} is the low frequency limit of the “A” transmitter waveform.

F_{Ahigh} is the high frequency limit of the “A” transmitter waveform.

F_{Blow} is the low frequency limit of the “B” transmitter waveform.

F_{Bhigh} is the high frequency limit of the “B” transmitter waveform.

N, M are the maximum order coefficients for the intermodulation product which can land a frequency within the frequency band of interest.

If this interference frequency range falls within, or is a part of the frequency range of interest, the union of the two frequency ranges is monitored for interference and subsequent correlation to the parent emissions. Using this and prior historical knowledge of the transmitter/interference frequency relationship, the instrument spends time measuring only signals which have a mathematical possibility of generating interference in the band of interest.

Preliminary Scoring

Each suspect which can generate interference is given a preliminary ranking or score depending upon several factors. Some of these factors include but are not limited to:

1 Power output of the transmitter(s);

2 Distance to the transmitter(s);

3 Distance between the transmitters;

4 The frequency of the transmitter(s) and the associated interference signal; and

5 The order of the intermodulation (“IM”) product produced by the transmitter landing within the band of interest.

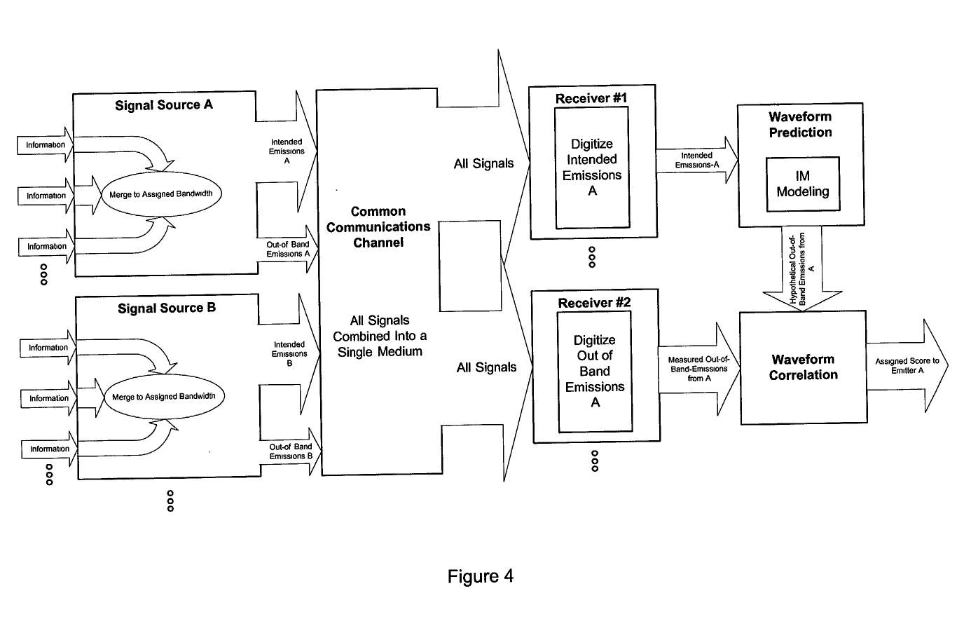

This ranked suspect (hypothetical interferer) list is used as a starting point for empirical measurements to further refine the score. This process is generally illustrated in FIG. 4. The correlation methods used to refine the list include Complex Signal Correlation and Spectral Event Correlation, as discussed herein below.

Complex Signal Correlation.

The instrument's internal controller and inherent software determines how each of the three receivers will be tuned by relying on the fundamental relationship between a transmitter's intended frequency emissions and range of interference frequencies which will be generated by these intended emissions. Alternatively, a stand alone personal computer (PC) could be used to accomplish the same purpose. The spectral signature (magnitude and phase) of this interference (otherwise known as the hypothetical interference signature) is readily calculated by mathematically combining the measured signatures of the parent transmitted waveforms.

It should be noted that the following description generally describes two parent transmission waveforms to provide a concise and clear description of the method used. It should be recognized, however, that this method applies equally to an arbitrary number of waveforms which can combine to generate an interference waveform.

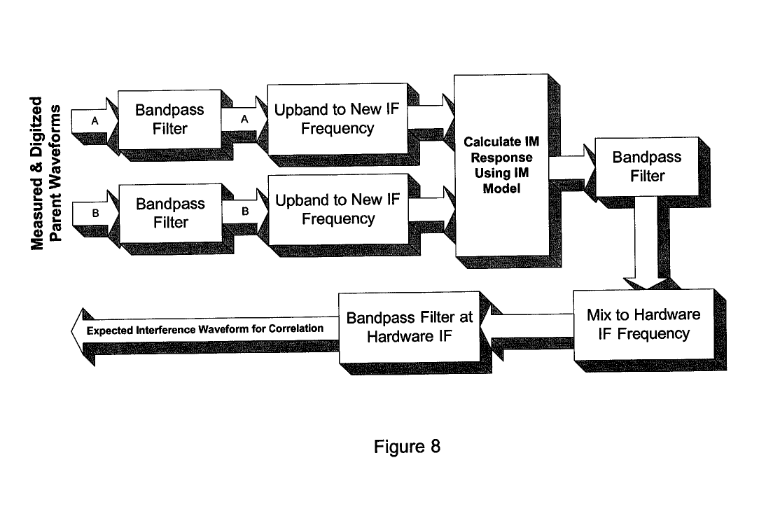

The signal flow to generate the interference signature is shown in FIG. 8. In the first step, each parent carrier waveform is up-banded from the original IF frequency sampled by the receiver to a higher IF frequency. This higher frequency is selected as the lowest frequency which can contain the following:

BW=(n+m)*[(F_{Ahigh}−F_{Alow})+(F_{Bhigh}−F_{Blow})]

where

BW is the IM coefficient on the “A” carrier which, in combination with the specified “m” value, produces an IM response within the band of interest.

n is the total bandwidth occupied by the IM signal created by the combination of the “A” and “B” waveforms.

m is the IM coefficient on the “B” carrier which, in combination with the specified “n” value, produces an IM response within the band of interest.

F_{A} is the high and low end of the “A” RF waveform frequency range.

F_{B} is the high and low end of the “B” RF waveform frequency range.

Once up-banded, the two waveforms are combined to generate the expected interference waveform which would be produced by these two carriers. A variety of mathematical techniques may be used to perform this combination. One implementation is a simple polynomial expansion whose order matches the order of the intermodulation product that will produce an interference signal within the band of interest. This expression is given by:

$${h}_{i} = \frac{{g}_{i}}{2} + {\sum }_{i = 0}^{( R - 3 ) / 2} {a}_{i} {g}_{i}^{i} for even R$$

$${h}_{i} = \frac{{g}_{i}}{2} + {\sum }_{i = 0}^{( R - 2 ) / 2} {a}_{i} {g}_{i}^{i} for odd R$$

$${q}_{i} = BPF ( {h}_{i} )$$

$$\text{where:}$$

$$R = n + m$$

$$g ( i ) = \frac{{x}_{i} {y}_{i}}{MAX \{ {x}_{i} {y}_{i} \}}$$

hᵢ is the unfiltered non-linear combination of the two transmit waveforms xᵢ and yᵢ.

aᵢ are the coefficients utilized in the polynomial expansion which is used to combine the two waveforms xᵢ and yᵢ. Normally, a₀=0, a₁=0.5, and all other values of a are equal to −1. However, improved correlation results can be obtained by tailoring these coefficients to match the actual non-linear phenomenon which is causing the interference.

qᵢ is the signal hᵢ bandpass filtered about the center frequency of the expected interference signal with a bandwidth which matches the union of the expected interference bandwidth and the bandwidth of interest.

Normally an FIR bandpass filter is used, although others are filter implementations are equally applicable.

R is the sum of the integer multipliers on each of the waveforms which are combining to produce the interference waveform. Also referred to as the “order” of the intermodulation product.

xᵢ is the measured waveform of the first transmit signal

yᵢ is the measured waveform of the second transmit signal

A feature of significance in the above calculations is that the method of calculating odd and even order interference is unique. By splitting the calculations in this way, the content of the resulting expected interference is minimized to contain only the spectral products which can land within the frequency range of interest. Sample-domain signal content which falls outside the band if interest is minimized thus increasing the sensitivity of the subsequent correlation process. Further, by truncating the order of the polynomial expansion to match the order of the IM coefficients which cause the resulting interference waveform to fall within the frequency range of interest, the computations are made more efficient due to a minimized sample rate requirement.

A second, more computationally efficient method which can be used to combine the transmit waveforms is given by:

$${h}_{i} = {\sum }_{i = 0}^{R} [ \frac{{x}^{( R - i )} {y}^{i}}{i !} {\prod }_{k = 0}^{i - 1} ( R - k ) ]$$

The disadvantage to this second method is that the spectral content of the resulting waveform cannot be readily tailored to match only the responses of interest within frequency band of interest.

Using either technique and other similar methods, the signal resulting from the combination of the up-banded “A” and “B” waveforms is down-converted to the same IF frequency utilized by the instrument's receiver. The signal is then decimated to match the sampling rate of the receiver. Matching the expected IM waveform's characteristics (IF frequency and sampling rate) allows the cross-correlation between this expected (or hypothetical) and the actual measured interference waveform to be readily performed.

At this point, the interference signature which would be produced by the suspect transmitter(s) is digitally and completely represented within the instrument at the sampling rate and IF frequency of the receivers. Because the instrument's internal receivers perform coherent and simultaneous sampling, the hypothetical complex interference waveform derived above can be correlated with the actual measured interference waveform. The degree of correlation can be used to determine if the transmitters being tested are responsible for the measured interference. The expression used to perform the signal correlation is given by:

R_{xy}^{ᵢ}=r_{i-(N-1)} for i=0,1,2, . . . (2N-1)

$${r}_{i} = {\sum }_{k = 0}^{N - 1} {q}_{k} {\hat{q}}_{j + k} for j = - ( N - 1 ) , - ( N - 2 ) , … ( N - 1 )$$

where:

q is the filtered, expected interference waveform at the measurement sample rate and IF frequency.

\acute{q} is the filtered, measured interference waveform at the measurement sample rate and IF frequency.

R_{xy} is the cross correlation of the measured and expected interference waveforms.

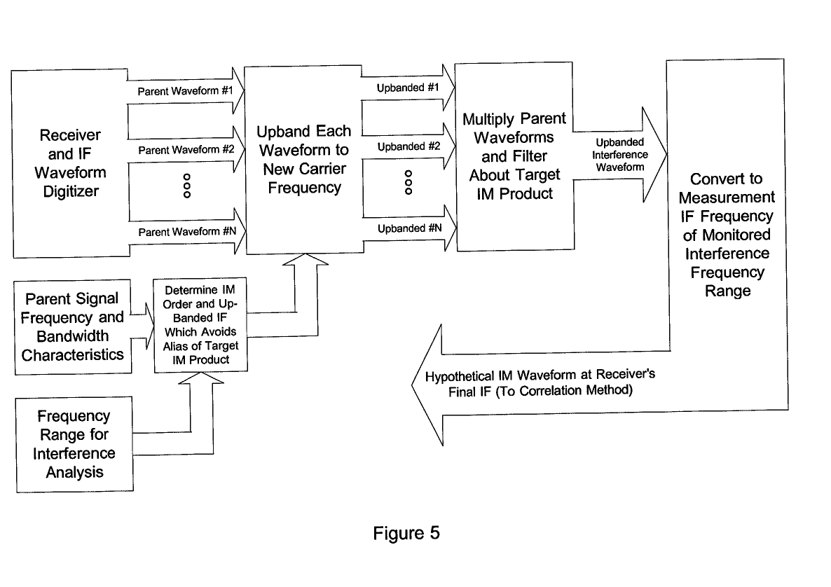

This prediction and correlation method is conceptually illustrated by the block diagram provided in FIG. 5. One exceptional advantage to this technique is that interference signals which appear nominally below the magnitude noise level of a typical spectrum analyzer can still produce clear correlated agreement with the hypothesized interference waveform. Because a complex correlation is performed, both magnitude and phase information is leveraged to detect if a relationship exists between the measured interference and the suspect transmitters even when the presence of interference might not be visible with a traditional scalar spectrum analyzer.

A second benefit of utilizing complex signal correlation to detect interference is its relative immunity to the presence of normal communications traffic during testing. This is important as it allows for normal communication systems operation while interference is being detected and the source of the interference is being identified.

The sample and frequency domain characteristics of the cross-correlation result are used to generate a change in relative score (relative ranking in the suspect list) for the specific suspect transmitter pair under evaluation.

Event Correlation.

The Event Correlation Technique evaluates the measured power envelope of both the transmitter(s) and the interference bands. This envelope is continuously sampled in both frequency and time. Co-incident occurrences of power envelope changes (increases or decrease in power level or shifting of frequency) indicate an increased statistical likelihood that the transmitters being measured are responsible for the interference being measured. The expression used to evaluate the occurrence of correlated events is:

$${S}_{{A}_{j}} = σ \{ {A}_{j} ( f ) \} for j = 0 , 1 , 2 , … J$$

$${E}_{{A}_{j}} = TRUE iff \vert {A}_{j} - {A}_{j - 1} \vert > k * {S}_{{A}_{j}}$$

where:

S_{A}^{ⱼ} is the standard deviation of the last (most recent) “J” samples at a frequency “f”

E_{A}^{ⱼ} is a Boolean indicating the detection of a spectral event (power envelope transition) for the waveform “A”

If an event is detected at the same time in any of the monitored transmit spectra and an event is detected in the monitored band of interest, the occurrence of a correlated spectral event is recorded. The number and location of these events are used in generating a relative score for the suspect transmitters being monitored.

Score Adjustment Based on Test Results

To aid in describing the following capability, let the word “suspect” represent one transmitter, or a combination of transmitters, that is capable of generating interference within the band of interest.

As more than one suspect can be simultaneously generating interference within the band of interest, the instrument includes the ability to track each suspect with a score. The score is incrementally adjusted with each successive test. When the instrument has completed a measurement operation, the list of suspects is re-ranked in order of decreasing likelihood of being a cause of interference in the band of interest. The suspects appearing at the top of the list are the most likely causes of the interference that is degrading communication system quality and/or capacity. Those appearing at the bottom of the list are the suspects least likely to be causing interference within the band of interest. This information is conveyed in the visual display and/or transmission of reports indicated in FIG. 3.

The number of receivers, their instantaneous bandwidth, their frequency range, and their assignment to a particular task in this embodiment is a matter of economic vs. performance tradeoffs. Alternative implementations which vary the type, bandwidth, frequency range, and/or architecture of the receivers are not considered to be a significantly different embodiment than the preferred embodiment illustrated in the present invention. Although the present invention has been described in conjunction with its preferred embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. An apparatus adapted for identifying sources of radio frequency interference, comprising:
a plurality of receivers adapted for receiving and measuring radio signals at multiple bandwidths which are generated by one or more transmitters at one or more locations;
a data input means;
a data storage means for storing information related to the location and signals generated by each of said one or more transmitters; and
a central processing unit for creating a hypothetical interference signature from said one or more transmitters and correlating this hypothetical interference signature with an actual interference signature measured from said one or more transmitters, wherein a visual display identifying a relative likelihood that said one or more transmitters is generating the radio frequency interference may be identified.

2. The apparatus of claim 1, further comprising a global positioning apparatus receiver for identifying a physical location of the apparatus with respect to said one or more transmitters.

3. The apparatus of claim 1, further comprising output means for generating a report of said visual display.

4. The apparatus of claim 1, further comprising a steerable directional antenna operably interconnected to said plurality of receivers for receiving information related to the direction and amplitude of radio signals generated from said one or more transmitters.

5. The apparatus of claim 1, wherein said central processing unit comprises a personal computer.

6. The apparatus of claim 1, wherein said data input means comprises a touch screen display.

7. The apparatus of claim 1, wherein said data input means comprises a computer keyboard.

8. The apparatus of claim 3, wherein said output means comprises a printed report.

9. The apparatus of claim 3, wherein said output means comprises sending an electronic message including said visual display.

10. The apparatus of claim 1, wherein said data storage means includes data related to a mathematical relationship between the hypothetical interference signature and the actual interference signature.

11. The apparatus of claim 1, wherein said data storage means comprises a computer hard drive.

12. The apparatus of claim 1, wherein said visual display includes a ranking system which identifies the likelihood that any one of said one or more transmitters is creating excessive levels of radio frequency interference.

13. A method for finding and identifying sources of radio frequency interference, comprising the steps of:
identifying a geographical location of an apparatus having at least one receiver adapted for receiving radio signals at multiple bandwidths;
receiving and measuring radio signals with said at least one receiver, said radio signals generated from one or more transmitters positioned at one or more physical locations;
storing data in a data storage means, the data related to a location and the radio signals generated from each of said one or more transmitters;
generating a hypothetical interference signature from signals received from said one or more transmitters and from the data known about each of said one or more transmitters;
correlating said hypothetical interference signature with a signal measured from one of the said receivers; and
identifying which of said one or more transmitters is creating the radio frequency interference.

14. The method of claim 13, further comprising the step of generating a visual display of information related to said one or more transmitters creating the radio frequency interference.

15. The method of claim 13, wherein said storing data step comprises providing data related to a mathematical relationship between said actual interference signature and said hypothetical interference signature.

16. The method of claim 13, wherein said at least one receiver is interconnected to a steerable antenna which is positioned in relation to said one or more transmitters to receive the radio signals at multiple bandwidths.

17. The method of claim 13, wherein said identifying a geographical location step comprises using a one of at least a global positioning system and map coordinates.

18. An apparatus adapted for identifying sources of electromagnetic interference, comprising:
one or more receivers adapted for receiving and measuring electromagnetic emissions at one or more bandwidths and center frequency pairs which are generated by one or more transmitters at one or more locations;
a data storage means which stores information related to the location and signals generated by said one or more transmitters and information related to the historical or expected emissions generated by said one or more transmitters;
a data input means;
a central processing unit for identifying the relative likelihood that said one or more transmitters can generate significant levels of intermodulated related interference in a specified bandwidth based on at least one of a historical, empirical and regulatory data containing operating characteristics of nearby transmitters.

19. The apparatus of claim 18, further comprising output means for generating a visual display of information used to produce a report of said one or more transmitters which may be creating radio frequency interference.

20. The apparatus of claim 18, further comprising a directional antenna operably interconnected to said one or more receivers for receiving information related to the direction and amplitude of electromagnetic emissions generated from said one or more transmitters.

21. The apparatus of claim 18, wherein said central processing unit comprises a personal computer.

22. The apparatus of claim 18, wherein said data input means comprises a touch screen display.

23. The apparatus of claim 18, wherein said output means comprises a printer.

24. The apparatus of claim 18, wherein said output means comprises an electronic communication of said report.

25. The apparatus of claim 18, wherein said data storage means is located externally to said apparatus.

26. The apparatus of claim 18, wherein said central processing unit further detects coincident changes in measured emissions levels from one or more of said plurality of transmitters and a measured level of electromagnetic interference, wherein a visual display identifying a relative likelihood that said one or more transmitters is generating the electromagnetic interference is provided.

27. The apparatus of claim 18, wherein said central processing unit further identifies a hypothetical interference signature from said one or more transmitters which can generate information based on transmitter characteristics data to identify a relative likelihood that said one or more transmitters is generating radio frequency interference.

28. A method for finding and identifying sources of electromagnetic interference, comprising:
identifying the geographical location of the interference event;
characterizing an electromagnetic environment by receiving and measuring electromagnetic signals with one or more electromagnetic signal receivers, said signals generated from one or more transmitters positioned at one or more physical locations;
providing input data into a data storage means which is related to the physical location and emissions characteristics of the radio signals generated from said one or more transmitters;
creating a hypothetical list of transmitters (and/or combinations of transmitters) which can generate interference within one or more specified frequency ranges based on at least one of measured, operator-entered, and stored data.
determining the relative likelihood that at least one of said one or more transmitters is creating the radio frequency interference; and
generating a visual display of information related to said relative likelihood that said one or more transmitters is creating the radio frequency interference.

29. The method of claim 28, wherein said providing input data step further comprises entering data related to a regulatory license database.

30. The method of claim 28, wherein said inputting data step further comprises providing data which is automatically generated based on measured data related to said one or more transmitters.

31. The method of claim 28, wherein said identifying the geographical location step is established using a displayed map.

32. The method of claim 28, wherein said identifying the geographical location step is established using latitude and longitude coordinates from at least one of a global positioning system and map data.

33. The method of claim 28, wherein said one or more receivers are interconnected to one or more antennas which provides amplitude and direction of origin information about said one or more transmitters.

34. The method of claim 28, wherein said determining step is achieved by generating a hypothetical interference signature based on measured signals from said one or more transmitters and correlating said hypothetical interference signature to a measured interference signature.

35. The method of claim 28, wherein said determining step is achieved by assigning a relative score to each of said one or more transmitters based on the nature of the likely interference, a relative power level of the transmitter(s), and a proximity of said one or more transmitters to a physical location of the interference event.

36. An apparatus for identifying a source of unwanted radio frequency interference, comprising:
a device for determining a geographic position of said apparatus;
a data storage device, wherein said data storage device contains information related to a location and expected radio frequency emission signature of each of a plurality of radio frequency transmitters;
a radio frequency receiver, wherein an actual radio frequency emission pattern at said geographic position of said apparatus is measured;
a central processing unit interconnected to said data storage device, wherein an expected radio frequency emission pattern at said geographic position of said apparatus can be calculated from said information related to a location and expected radio frequency emission signature of each of said radio frequency emission sources and from said geographic position of said apparatus, and wherein said expected radio frequency emission pattern at said geographic position of said apparatus is compared to an actual radio frequency emission pattern detected by said radio frequency receiver to identify a most likely source of said unwanted radio frequency interference.

37. The apparatus of claim 36, further comprising an output device, wherein said most likely source of said unwanted radio frequency interference is identified in a visual report.

38. The apparatus of claim 36, wherein said device for determining a geographic position of said apparatus is a global positioning system.

39. A method for identifying a source of unwanted radio frequency interference, comprising:
calculating an expected radio frequency signature at a selected geographic position from location and measured emission information related to a plurality of radio frequency sources;
measuring an actual radio frequency signature at said selected position; and
comparing said expected radio frequency signature at said selected geographic position to said measured radio frequency signature at said selected geographic position, wherein at least one of said plurality of radio frequency sources is identified as a most likely source of said unwanted radio frequency interference.
